(19) United States
(12) Patent Application Publication
(10) Pub. No.: US 2024/0186762 A1
(43) Pub. Date: Jun. 6, 2024

(54) LASER ELEMENT AND LASER DEVICE

(71) Applicants: TOKUSHIMA UNIVERSITY, Tokushima-shi (JP); NICHIA CORPORATION, Anan-shi (JP)

(72) Inventors: Tetsuro KATAYAMA, Tokushima-shi (JP); Takeshi KIHARA, Tokushima-shi (JP)

(73) Assignees: TOKUSHIMA UNIVERSITY, Tokushima-shi (JP); NICHIA CORPORATION, Anan-shi (JP)

(21) Appl. No.: 18/523,031

(22) Filed: Nov. 29, 2023

(30) Foreign Application Priority Data
Nov. 30, 2022 (JP) 2022-191437

(51) Int. Cl. H01S 3/16; H01S 3/02

(52) U.S. Cl. CPC H01S 3/163; H01S 3/027

(57) ABSTRACT

The laser element includes a gain medium and a photochromic compound that receives a carrier from the gain medium. The gain medium may contain: a first ion including at least one selected from the group consisting of an alkali metal ion, an ammonium ion, a formamidinium ion, a guanidium ion, an imidazolium ion, a pyridinium ion, a pyrrolidinium ion, and a protonated thiourea ion; a second ion including at least one selected from the group consisting of lead, germanium, tin, antimony, and bismuth; and an anion or a ligand including at least one selected from the group consisting of a chloride ion, a bromide ion, an iodide ion, a cyanide ion, a thiocyanate, an isothiocyanate, and a sulfide.

### CROSS-REFERENCE TO RELATED APPLICATION

This application claims priority to Japanese Patent Application No. 2022-191437, filed on Nov. 30, 2022, the disclosure of which is hereby incorporated by reference in its entirety.

### TECHNICAL FIELD

The present disclosure relates to a laser element and a laser device.

### BACKGROUND

Optoelectronics is expected as a technology for further increasing the speed of information and communication processing. The technology uses light as an information source, and thus transmission is fast, and electromagnetic interference does not occur in the micro-area so it is expected that high-speed information processing can be performed more compactly and with lower power as compared to conventional electronics. For a device in information processing using light, three optical technologies are required: a light-receiving element, a micro-laser, and an optical modulator. There are complementary processes of converting an optical signal into an electrical signal and converting an electrical signal into an optical signal. The thermal loss and signal noise generated in the conversion process is one of the issues that become bottlenecks in accuracy, speed, and amount of thermal loss of information processing in the optoelectronic technology.

With the above, Non-Patent Document of “Semiconductor nanoparticle system—Elucidation of optical switching mechanism of light-emitting state in photochromic molecule”, Annual Meeting of Photochemistry 2016 (Tokyo Komaba Campus), Sep. 8, 2016, Lecture No. 3D05 describes that in a system in which a photochromic molecule is adsorbed onto a semiconductor nanoparticle, an emission intensity of the semiconductor nanoparticle changes depending on a state of the photochromic molecule.

### SUMMARY

Here, if an optical signal can be amplified and/or modulated by another optical signal, it is possible to reduce the number of conversion elements for mutually converting an electrical signal and an optical signal. An object of one aspect of the present disclosure is to provide a laser element that can control lasing by an optical signal.

A first aspect is a laser element including a gain medium and a photochromic compound receiving a carrier from the gain medium. The gain medium in the laser element contains: a first ion, a second ion, and an anion or a ligand, the first ion including at least one selected from the group consisting of an alkali metal ion, an ammonium ion, a formamidinium ion, a guanidium ion, an imidazolium ion, a pyridinium ion, a pyrrolidinium ion, and a protonated thiourea ion, the second ion including at least one selected from the group consisting of lead, germanium, tin, antimony, and bismuth, and the anion or the ligand including at least one selected from the group consisting of a chloride ion, a bromide ion, an iodide ion, a cyanide ion, a thiocyanate, an isothiocyanate, and a sulfide, in its composition,

A second aspect is a laser device including: the laser element of the first aspect; a first light source configured to emit light having a first peak wavelength; and a second light source configured to emit light having a second peak wavelength. The first peak wavelength is a wavelength that allows the photochromic compound to be changed to a state in which reception of a carrier is suppressed, the second peak wavelength is a wavelength that allows the photochromic compound to be changed to a state in which reception of a carrier is possible, and at least one of the first peak wavelength or the second peak wavelength is a wavelength that allows the gain medium to be excited.

According to an aspect of the present disclosure, it is possible to provide a laser element that can control lasing by an optical signal.

### BRIEF DESCRIPTION OF DRAWINGS

FIG. 1 is a schematic cross-sectional view illustrating a configuration example of a laser device.

FIG. 2A is a schematic cross-sectional view illustrating a configuration example of a laser device.

FIG. 2B is a schematic cross-sectional view illustrating a configuration example of a laser device.

FIG. 3A is a schematic top view illustrating a configuration example of a laser device provided with a plurality of laser elements.

FIG. 3B is a schematic top view illustrating a configuration example of a laser device provided with a plurality of laser elements.

FIG. 4 is a schematic cross-sectional view illustrating a configuration example of the laser device provided with the plurality of laser elements.

FIG. 5 is a schematic top view illustrating a configuration example of a laser device provided with a plurality of laser elements.

FIG. 6 is a schematic cross-sectional view illustrating a configuration example of a light source device.

FIG. 7 is a graph showing nonlinear light emission by a crystal having a perovskite structure.

FIG. 8 is a graph showing control of lasing by ultraviolet irradiation.

FIG. 9A is a graph showing an infrared absorption spectrum of methylammonium lead bromide.

FIG. 9B is a graph showing an infrared absorption spectrum of a diarylethene derivative.

FIG. 9C is a graph showing an infrared absorption spectrum of a laser element according to Example 1.

### DETAILED DESCRIPTION

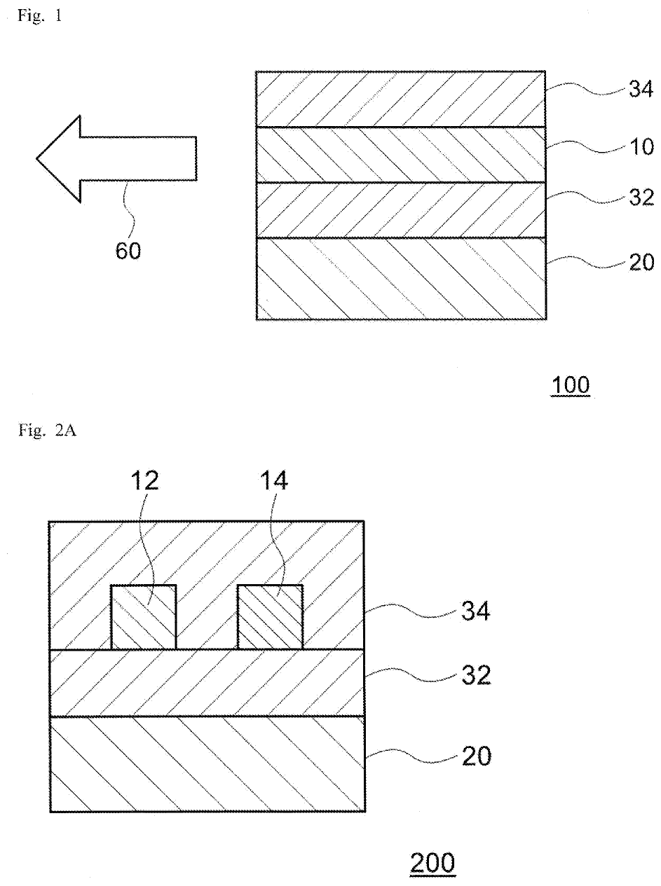

The word “step” herein includes not only an independent step but also a step that cannot be clearly distinguished from another step if the anticipated purpose of the step is achieved. If a plurality of substances applicable to a single component in a composition is present, the content of the single component in the composition means the total amount of the plurality of substances present in the composition, unless otherwise specified. Furthermore, concerning an upper limit and a lower limit of numerical ranges described herein, the numerical values exemplified as the numerical range can be freely selected and combined. In the present specification, in a case in which a portion such as a layer, a film, or a region is referred to as being “on” or “in an upper portion of” another element, this includes not only a case in which the portion is directly on the other element but also a case in which another portion is present between the portion and the other portion. Conversely, in a case in which a portion such as a layer, a film, a region, or a plate is referred to as being “under” or “in a lower portion of” another element, this includes not only a case in which the portion is directly under the other portion but also a case in which another portion is present between the portion and the other portion. In addition, in the present specification, being disposed “on” includes not only a case of being disposed in an upper portion but also a case of being disposed in a lower portion. In the drawings, the size of each element may be exaggerated for illustrative purposes and is not limited to an actual size or size relationship. Embodiments of the present disclosure will be described below in detail. However, the embodiments described below are merely examples of a laser element and a laser device for embodying the technical concept of the present invention, and the present invention is not limited to the laser elements and the laser devices described below. In the drawings, the same portions are given the same reference numerals. For ease of explanation or understanding of the points of view, the embodiments may be illustrated separately for convenience, but partial substitutions or combinations of the constituent components illustrated in different embodiments and examples are possible. In the drawings following FIG. 1, descriptions of matters common to those in the preceding drawings will be omitted, and only different features will be described. In particular, similar effects of similar configurations will not be mentioned each time for individual embodiments.

### Laser Element

A laser element includes a gain medium and a photochromic compound that receives a carrier from the gain medium. The gain medium includes, in its composition, a first ion, a second ion, and an anion or a ligand. The first ion includes at least one selected from the group consisting of an alkali metal ion, an ammonium ion, a formamidinium ion, a guanidium ion, an imidazolium ion, a pyridinium ion, a pyrrolidinium ion, and a protonated thiourea ion. The second ion includes at least one selected from the group consisting of lead, germanium, tin, antimony, and bismuth. The anion or the ligand includes at least one selected from the group consisting of a chloride ion, a bromide ion, an iodide ion, a cyanide ion, a thiocyanate, an isothiocyanate, and a sulfide.

The laser element including the gain medium has a specific composition and the photochromic compound disposed in such a manner that a carrier from the gain medium can be received can control lasing of the gain medium depending on the state of the photochromic compound. The state of the photochromic compound can be controlled by an optical signal, and thus the laser oscillation of the laser element is controlled by the optical signal.

### Gain Medium

The gain medium may include an ionic crystal including, in its composition, a first ion, a second ion, and an anion or a ligand, and may include a crystal having a perovskite structure. The first ion included in the gain medium may include at least one selected from the group consisting of an alkali metal ion, an ammonium ion, a formamidinium ion, a guanidium ion, an imidazolium ion, a pyridinium ion, a pyrrolidinium ion, and a protonated thiourea ion. The alkali metal ion included in the first ion may include at least one selected from the group consisting of lithium (Li), sodium (Na), potassium (K), rubidium (Rb), and cesium (Cs), for example. The ammonium ion may be represented by, for example, the following Formula (A-1). The formamidinium ion may be represented by, for example, the following Formula (A-2). The guanidinium ion may be represented by, for example, the following Formula (A-3), and the protonated thiourea ion may be represented by, for example, the following Formula (A-4). The imidazolium ion may be represented by, for example, the following Formula (A-5). The pyridinium ion may be represented by, for example, the following Formula (A-6). The pyrrolidinium ion may be represented by, for example, the following Formula (A-7). In each formula representing a non-metal cation, each R independently represents at least one selected from the group consisting of a hydrogen atom, an alkyl group having 1 to 4 carbon atoms, a phenyl group, a benzyl group, a halogen atom, and a pseudohalogen. Any two Rs in each formula may be bonded to each other to form a nitrogen-containing aliphatic ring having 3 to 6 carbon atoms.

[R₄N⁺] (A-1)

[(NR₂)₂RC⁺] (A-2)

[(NR₂)₃C⁺] (A-3)

[(NR₂)₂C⁺—SR] (A-4)

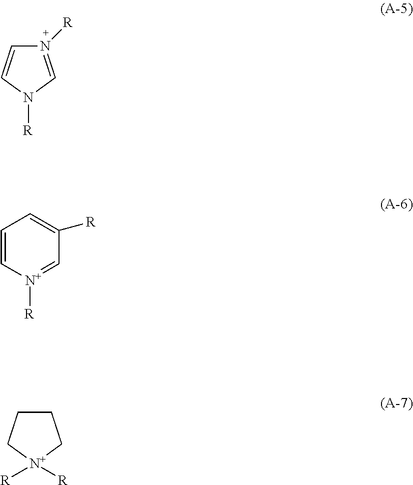

The second ion included in the gain medium may include at least one selected from the group consisting of lead (Pb), germanium (Ge), tin (Sn), antimony (Sb), and bismuth (Bi), and may include at least lead.

The anion or the ligand may include at least one selected from the group consisting of a chloride ion, a bromide ion, an iodide ion, a cyanide ion, a thiocyanate, an isothiocyanate, and a sulfide, and may include at least a bromide ion.

In the composition of the gain medium, for example, the total number of moles of the first ions may be in a range from 1 to 4, the total number of moles of the second ions may be in a range from 1 to 2, and the total number of moles of the anions or ligands may be in a range from 3 to 9.

The gain medium may have a composition represented by, for example, the following Formula (1):

[M¹_{w}A¹_{(1-w)}]ₓM²_{y}X_{z} (1)

In Formula (1), M¹ represents a first ion including at least one selected from the group consisting of Cs, Rb, K, Na, and Li. A¹ represents a non-metal cation including at least one selected from the group consisting of an ammonium ion, a formamidinium ion, a guanidium ion, an imidazolium ion, a pyridinium ion, a pyrrolidinium ion, and a protonated thiourea ion. M² represents the second ion including at least one selected from the group consisting of Ge, Sn, Pb, Sb, and Bi. X represents the anion or the ligand including at least one selected from the group consisting of a chloride ion, a bromide ion, an iodide ion, a cyanide ion, a thiocyanate, an isothiocyanate ion, and a sulfide ion.

x is a number in a range from 1 to 4, y is a number in a range from 1 to 2, z is a number in a range from 3 to 9, and w is a number in a range from 0 to 1. In Formula (1), in a case in which both the first ion M¹ and the non-metal cation A¹ are included, both the first ion M¹ and the non-metal cation A¹ represent an atomic group constituting a perovskite structure.

The details of the ammonium ion, the formamidinium ion, the guanidinium ion, the imidazolium ion, the pyridinium ion, the pyrrolidinium ion, and the protonated thiourea ion represented by A¹ are as described above.

In Formula (1), preferably, M¹ may include at least Cs, A¹ may include an ammonium ion, R in the ammonium ion may be an alkyl group having 1 to 4 carbon atoms, M² may include at least Pb, and X may include at least one selected from the group consisting of a chloride ion, a bromide ion, and an iodide ion.

The gain medium may have a composition represented by the following Formula (2a):

[M¹_{w}A¹_{(1-w)}]ₙM²X₂₊ₙ (2a)

In Formula (2a), M¹, A¹, M², and X have the same definitions as those in Formula (1). w is a number in a range from 0 to 1, and n is a number in a range from 1 to 4. In a case in which n=1 is satisfied, a three-dimensional perovskite structure is obtained. In a case in which n is 2 to 4, for example, it is considered that a low-dimensional perovskite structure in which an octahedron of the perovskite structure forms planes is obtained. The gain medium constituting the laser element preferably satisfies n=1 in Formula (2a).

The gain medium only needs to have at least the structure represented by the above Formula (2a) in the crystal. For example, both a layer of perovskite represented by the above Formula (2a) and a layer of rock-salt structure may be included.

The gain medium may have a composition represented by, for example, the following Formula (2b):

M¹₂[BiᵥA²₍₁₋ᵥ₎]₂X₆ (2b)

In Formula (2b), M¹ and X have the same meanings as those in Formula (1). A² indicates at least one selected from the group consisting of an ammonium ion, a formamidinium ion, a guanidium ion, an imidazolium ion, a pyridinium ion, a pyrrolidinium ion, a protonated thiourea ion, Li, Na, and K.

v is a number in a range from 0 to 1. In Formula (2b), in a case in which both the second ions Bi and A² are included, both the second ions Bi and A² represent an atomic group constituting a perovskite structure. The numerical values indicating the composition in Formula (2b) may be slightly changed within a range in which an electric charge is compensated. For example, Formula (2b) may be represented as M¹_{2+δ1}[BiᵥA²₍₁₋ᵥ₎]_{2+δ2}X_{6+δ3}, and δ1 and δ2 may be varied to compensate for an electrical charge in a range of −0.2 or more and 0.2 or less. δ3 may be varied to compensate for an electrical charge in a range of −0.6 or more and 0.6 or less.

Examples of the shape of the gain medium in the laser element include a rod, a sheet, a bulk, and a plate. When the shape of the gain medium is a rod, a Fabry-Perot resonator can be formed, for example. This case makes it easy to control the mode. Meanwhile, when the shape of the gain medium is a plate, a whispering gallery mode resonator can be formed, for example. This case is suitable for using a high-order mode. As to the size of the gain medium, for example, in a case in which the shape of the gain medium is approximated to a rod, a sheet, a plate, or the like, the total of a longitudinal length, a lateral length, and a height may be in a range from 500 nm to 50 μm, and preferably 1 μm or less. Here, the height of the gain medium is the maximum length in the elongated direction of a rod in a case in which the gain medium is approximated to a rod shape. The longitudinal length is the maximum distance between two points on the outer periphery of the gain medium in a plane perpendicular to the height direction. The lateral length is a distance between two points on the outer periphery of the gain medium in a plane perpendicular to the height direction and in a direction perpendicular to the longitudinal length direction.

In an absorption spectrum of the gain medium, a peak wavelength of an absorption intensity may be, for example, in a wavelength range from 300 nm to 900 nm, and preferably in a wavelength range from 400 nm to 500 nm. The gain medium may have a half-value width of the absorption peak in the absorption spectrum in a range, for example, from 10 nm to 300 nm, and preferably in a range from 30 nm to 200 nm. Here, the half-value width means a wavelength width (full width at half maximum: FWHM) of an absorption spectrum at which the absorption intensity is 50% of the maximum absorption intensity in the absorption spectrum of the gain medium.

For example, the gain medium including a crystal having a perovskite structure can be produced as follows. A thin film including a salt containing the second ion is formed by using an aqueous solution of the salt containing the second ion. A solution in which the first ion and the anion or the ligand are dissolved in an organic solvent such as alcohol is added to the formed thin film so that a crystal having a perovskite structure can be obtained. Examples of the organic solvents include alcohols having 1 to 4 carbon atoms. As to details of the method for producing a crystal having a perovskite structure, for example, the description of Haiming Zhu et al., Nature Mater. 14, 636-643 (2015), and the like can be referred to.

### Photochromic Compound

The photochromic compound disposed in such a manner that a carrier from the gain medium can be received is a compound that is reversibly isomerized between two states having different absorption spectra by light irradiation to exhibit a change in the color of a substance. The two states are a ring-opened state or a ring-closed state of the photochromic compound, and in these states, the photochromic compound is decolored or colored. When a carrier from the gain medium can be received, laser oscillation is suppressed. Meanwhile, when a carrier from the gain medium cannot be received, laser oscillation is not inhibited. Examples of the photochromic compounds include azobenzene derivatives, spiropyran derivatives, fulgide derivatives, and diarylethene derivatives.

As the photochromic compound, there are known a P-type compound that changes its molecular structure by light irradiation and then returns to its original structure by light irradiation of another wavelength, and a T-type compound that returns to its original structure not only by light irradiation but also by a thermal reaction. The photochromic compound used in the laser element may be either the P-type compound or the T-type compound but is preferably the P-type compound from the viewpoint of light controllability. In addition, when the P-type compound is used, repetition durability of coloring and decoloring or thermal stability of the two states can be improved. Examples of the P-type photochromic compound include fulgide derivatives and diarylethene derivatives. From the viewpoint of the repetition durability of coloring and decoloring, the photochromic compound preferably contains at least a diarylethene derivative. Furthermore, the diarylethene derivative is decolored immediately after excitation in a ring-closed form and a change in molecular structure in a photoexcited state proceeds in about 500 femtoseconds in a ring-opened form. In consideration of the fact that the thermal relaxation time of a carrier in a general semiconductor element is about several picoseconds to several nanoseconds, 500 femtoseconds is sufficiently fast. Accordingly, a photoisomerization reaction rate of the diarylethene derivative can exceed a laser oscillation rate by a photoelectric conversion process of the gain medium in the related art. As a result, in the laser element, switching control can be performed at a speed higher by one to four orders of magnitude than switching in the photoelectric conversion process.

Examples of the diarylethene derivative include a compound represented by the following Formula (3):

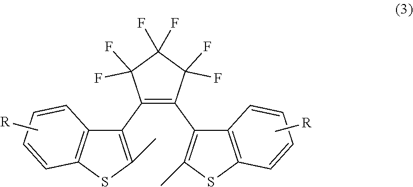

In Formula (3), R represents a carboxy group, a phosphono group, a nitro group, a sulfo group, an alkyl group, a halogen atom, an aryl group which may have a substituent, or the like. The substitution position of R in Formula (3) may be, for example, a 6-position of a benzothiophene ring.

The photochromic compound has a different wavelength of light at which the carrier can be received, depending on its structure or the like. In the photochromic compound constituting the laser element, the wavelength of light for changing the photochromic compound to a state in which a carrier from the gain medium can be received may be included in at least a part of a wavelength range in which a transmitted light intensity is 50% or more of the maximum value thereof in the absorption spectrum of the gain medium. The wavelength that allows the photochromic compound to be changed to a state in which a carrier can be received may preferably be included in a wavelength range in which the transmitted light intensity in the absorption spectrum of the gain medium is 70% or more, or 80% or more of the maximum value thereof. As a result, the photochromic compound can be efficiently brought into a state in which a carrier can be received.

In one aspect, in the photochromic compound constituting the laser element, the wavelength of light for changing the photochromic compound to a state in which a carrier from the gain medium can be received may be in a wavelength range from 400 nm to 900 nm, and preferably in a wavelength range of 700 nm or shorter. In addition, in the photochromic compound, the wavelength of light for changing the photochromic compound to a state in which reception of a carrier from the gain medium is suppressed may be in a wavelength range from 200 nm or longer to shorter than 400 nm, and preferably in a wavelength range of 260 nm or longer, or 350 nm or shorter.

The photochromic compound in the laser element may be disposed in such a manner that a carrier from the gain medium can be received. The photochromic compound may, for example, be adsorbed onto the gain medium. This brings the gain medium and the photochromic compound close to each other, and when the photochromic compound is in a state in which a carrier can be received, the carrier can be efficiently received from the gain medium. The adsorption of the photochromic compound onto the gain medium may be, for example, any one of adsorption by electrostatic force between a functional group of the photochromic compound and the gain medium, adsorption by physical force such as van der Waals force, and chemical adsorption involving a covalent bond.

Examples of the functional group which enables absorption of the photochromic compound onto the gain medium include a carboxy group and a phosphono group. In a case in which the adsorption of the photochromic compound onto the gain medium is derived from a functional group, an adsorption state of the photochromic compound onto the gain medium can be estimated by, for example, observing an infrared absorption spectrum specific to the functional group.

The adsorption of the photochromic compound onto the gain medium can be accomplished, for example, by a method including bringing a solution of the photochromic compound into contact with the gain medium and removing at least a part of a solvent from the solution of the photochromic compound in contact with the gain medium. Examples of the solvent constituting the solution of the photochromic compound include alcohols having 1 to 4 carbon atoms. The solvent can be removed from the solution of the photochromic compound by, for example, air drying, heat drying, or drying under reduced pressure.

The gain medium and the photochromic compound constituting the laser element may be accommodated in a container. When the gain medium and the photochromic compound are accommodated in the container, the repetition durability tends to be further improved. The container may be a sealed container in which the ingress of gas from the outside into the interior of the container is limited. The shape of the container may be, for example, a plate shape, a block shape, or the like. The material of the container may be, for example, glass, stainless steel (SUS), or the like.

The size of the container only needs to be selected depending on amounts of the gain medium and the photochromic compound to be accommodated, and may be a capacity in a range from 200 vol % to 100,000 vol % for volumes of the gain medium and the photochromic compound to be accommodated. As to the size of the container, in a case in which a length in a direction perpendicular to an emission surface of laser light is defined as the height of the container, the maximum distance between two points on the emission surface is defined as a longitudinal length of the container, and a length in a direction perpendicular to the longitudinal length direction of the container on the emission surface is defined as a lateral length of the container. The height of the container may be in a range from 1000 μm to 10000 μm, the longitudinal length of the container may be in a range from 1000 μm to 10000 μm, and the lateral length of the container may be in a range from 1 μm to 1000 μm.

The container accommodating the gain medium and a photochromic compound may be filled with an inert gas. When the inert gas is filled, the repetition durability of coloring and decoloring and the light resistance of the gain medium tends to be further improved. Examples of the inert gas filled in the container include a rare gas such as argon gas, and nitrogen gas. In a case in which the container is filled with inert gas, the content of the inert gas in the container may be, for example, 90 vol % or more, and preferably 99 vol % or more, relative to the capacity of the container.

### Laser Device

The laser device may include at least one of the laser elements described above, at least one first light source configured to emit light having the first peak wavelength, and at least one second light source configured to emit light having the second peak wavelength. The first peak wavelength, which is the peak wavelength of the light emitted by the first light source, may be a wavelength that allows the photochromic compound to be changed to a state in which the reception of a carrier is suppressed. The second peak wavelength, which is the peak wavelength of the light emitted by the second light source, may be a wavelength that allows the photochromic compound to be changed to a state in which a carrier can be received. At least one of the first peak wavelength and the second peak wavelength may be a wavelength that can excite the gain medium. The first light source and the second light source may be disposed in such a manner that the laser element can be irradiated with light from the first light source and the second light source.

In the laser device, the gain medium is excited by at least one of the first light source and the second light source to perform laser oscillation. For example, in a case in which the gain medium is excited by light emitted by the first light source, the photochromic compound is brought into a state in which a carrier from the gain medium can be received by light emitted by the second light source so that laser oscillation is stopped by energy transfer from the gain medium. Meanwhile, when the photochromic compound enters a state in which the reception of a carrier from the gain medium is suppressed by the light emitted from the first light source, laser oscillation is performed again. Accordingly, it is possible to control the laser oscillation of the laser element by controlling the light emission of the first light source and the second light source as an optical signal.

As the light source included in the laser device, a light emitting diode, a laser diode, or the like can be used. The light source is preferably a laser diode and may be an edge-emitting semiconductor laser or a surface-emitting semiconductor laser. In one aspect, the first peak wavelength of the first light source may be, for example, in a range from 200 nm or longer to shorter than 400 nm, and preferably 260 nm or longer, or 350 nm or shorter. The second peak wavelength of the second light source may be, for example, in a range from 400 nm to 900 nm, and preferably 700 nm or shorter.

The laser element included in the laser device can nonlinearly emit light in a range, for example, from 350 nm to 1100 nm, and preferably 450 nm or longer, or 650 nm or shorter. A half-value width at the time of nonlinearly emitting light may be, for example, in a range from 0.5 nm to 500 nm, preferably 1 nm or greater, or 10 nm or greater, and preferably 500 nm or less, or 100 nm or less.

The laser device may further include a light transmissive member that covers at least a part of the surface of the laser element. The resistance of the laser element can be improved by providing the light transmissive member. Examples of the material of the light transmissive member include silicon oxide, aluminum oxide, titanium oxide, tantalum oxide, niobium oxide, silicon nitride, aluminum nitride, silicon oxynitride, and glass. The thickness of the light transmissive member may be, for example, in a range from 1 time to 100 times, preferably 2 times or more, or 20 times or less the longitudinal length of the laser element.

In a case in which the laser device includes the light transmissive member, the laser device may include a first light transmissive member disposed on a first surface, which is one surface of the laser element, and a second light transmissive member disposed on a second surface opposite to the first surface of the laser element. That is, the laser element may be disposed between the first light transmissive member and the second light transmissive member. The first light transmissive member and the second light transmissive member may independently cover at least a part of the first surface and the second surface of the laser element, respectively, or may continuously cover at least a part of the first surface and the second surface of the laser element to form an integrated light transmissive member.

An example of the laser device including the light transmissive member will be described with reference to the drawings. FIG. 1 is a cross-sectional view of a laser device 100 and is a schematic cross-sectional view taken along a plane parallel to an emission direction 60 of laser light. The laser device 100 includes a laser element 10, and a first light transmissive member 32 and a second light transmissive member 34 sandwiching the laser element 10. The quantity of the laser elements 10 may be one or more than one. In the laser device 100, a light source 20 and the laser element 10 are disposed with the first light transmissive member 32 interposed therebetween. Light from the light source 20 is applied to the laser element 10 through the first light transmissive member 32 to control lasing of the laser element. In the laser device 100, the laser element 10 is located between the first light transmissive member 32 and the second light transmissive member 34, and thus the laser element is protected to improve the resistance. The thickness of the first light transmissive member 32 may be larger than the thickness of the second light transmissive member 34. Accordingly, heat from the light source 20 can be away from the laser element 10. The first light transmissive member 32 and the second light transmissive member 34 preferably have a refractive index smaller than that of the laser element 10. This can confine light efficiently. Accordingly, the first light transmissive member 32 and the second light transmissive member 34 are preferably formed of, for example, silicon oxide, aluminum oxide, silicon nitride, aluminum nitride, or the like. In the laser device 100, a surface of the laser element 10 perpendicular to the plane of the drawing may be covered with the first light transmissive member 32 or the second light transmissive member 34 or may be exposed on the surface of the laser device 100. A surface of the laser element 10 opposite to the emission surface may be covered with the first light transmissive member 32 or the second light transmissive member 34 or may be exposed on the surface of the laser device 100.

The laser device may include a plurality of laser elements, and at least a part of each of the laser elements may be covered with a light transmissive member. That is, the laser device may include at least a first laser element and a second laser element as the laser elements, and in a cross section including a first light transmissive member, a second light transmissive member, the first laser element, and the second laser element, the first laser element and the second laser element may be surrounded by the first light transmissive member and the second light transmissive member, respectively, and at least one of the first light transmissive member or the second light transmissive member may be disposed between the first laser element and the second laser element.

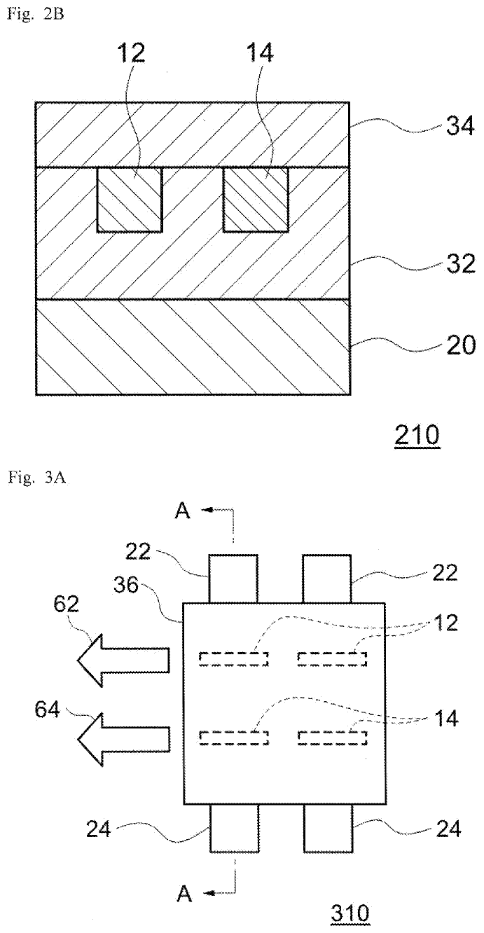

A configuration example of the laser device including a plurality of laser elements will be described about the drawings. FIG. 2A is a cross-sectional view of a laser device 200 and is a schematic cross-sectional view in a plane perpendicular to an emission direction of laser light. The laser device 200 includes a first laser element 12, a second laser element 14, and a first light transmissive member 32 and a second light transmissive member 34 sandwiching the first laser element 12 and the second laser element 14. Lasing wavelengths of the first laser element 12 and the second laser element 14 may be different from each other. Lateral surfaces of the first laser element 12 and the second laser element 14 are covered with the second light transmissive member 34, and the first laser element 12 and the second laser element 14 are separated from each other by the second light transmissive member 34. FIG. 2B is a cross-sectional view of a laser device 210 and is a schematic cross-sectional view in a plane perpendicular to the emission direction of the laser light. The laser device 210 includes a first laser element 12, a second laser element 14, and a first light transmissive member 32 and a second light transmissive member 34 sandwiching the first laser element 12 and the second laser element 14. Lateral surfaces of the first laser element 12 and the second laser element 14 are covered with the first light transmissive member 32, and the first laser element 12 and the second laser element 14 are separated from each other by the first light transmissive member 32. As a result, upper surfaces, lower surfaces, and the lateral surfaces of the first laser element 12 and the second laser element 14 are protected, thereby further improving the resistance. Although cases in which the number of laser elements is two are illustrated in FIGS. 2A and 2B, the laser device may include three or more laser elements. The three or more laser elements can include the first laser element 12, the second laser element 14, and one or more other laser element(s). The other laser element(s) may be disposed in parallel with the first laser element 12 and the second laser element 14. The other laser element(s) may have the same oscillation wavelength as that of the first laser element or the second laser element or may have a different oscillation wavelength.

The laser device may further include a light transmissive member, a first light source, a second light source, and an optical waveguide optically coupled to each of the first light source and the second light source. The laser elements and the light transmissive member may be disposed on the optical waveguide, and the laser elements may be located between the optical waveguide and the light transmissive member. The optical waveguide constituting the laser device may be, for example, a planar lightwave circuit. The optical waveguide may include, for example, a grating coupler. This can allow the laser elements to be efficiently irradiated with excitation light from the first light source and the second light source. In addition, the optical waveguide may include a curved waveguide, a tapered waveguide, a Y-branch waveguide, a directional coupler, an arrayed waveguide grating, a multimode interferometer, a Mach-Zehnder interferometer, or the like.

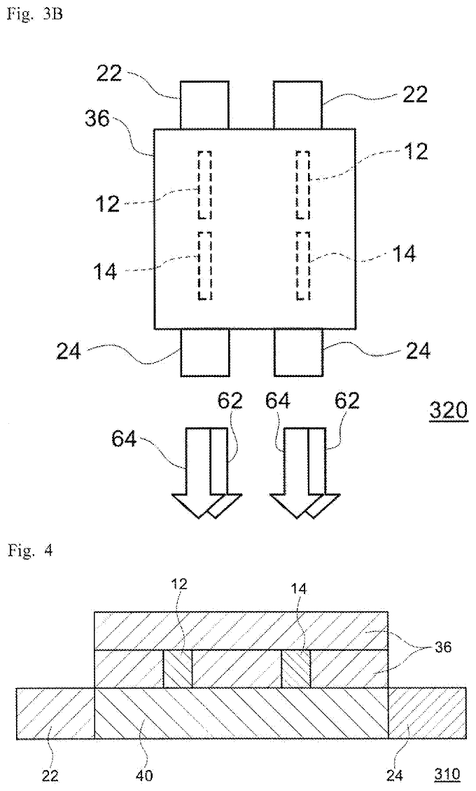

FIG. 3A is a schematic top view illustrating a configuration example of a laser device 310 including an optical waveguide optically coupled to each of a first light source and a second light source, and FIG. 4 is a schematic cross-sectional view taken along line A-A of FIG. 3A. In the laser device 310, an optical waveguide 40 has an upper surface and a lower surface opposite to the upper surface, and lateral surfaces connecting the upper surface and the lower surface. The laser device 310 has a plate shape having a thickness equal to the height of its lateral surfaces. The first light sources 22 optically coupled are located at one of the lateral surfaces of the optical waveguide 40. The second light sources 24 optically coupled are located at one of the lateral surfaces opposite to the lateral surface on which the first light sources 22 are disposed. The first laser elements 12 and the second laser elements 14 are spaced apart from each other on the upper surface of the optical waveguide 40 and are optically coupled to the optical waveguide 40. The first laser elements 12 and the second laser elements 14 are located between the optical waveguide 40 and a third light transmissive member 36. The laser device 310 includes at least two first laser elements 12 and at least two second laser elements 14. The first laser elements 12 are disposed in such a manner that first emission light 62 from the plurality of first laser elements 12 is emitted in the same direction. The second laser elements 14 are disposed in such a manner that second emission light 64 from the plurality of second laser elements 14 is emitted in the same direction as the first emission light 62 from the first laser elements 12. In the laser device 310, the first emission light 62 and the second emission light 64 are emitted in a direction different from the direction in which the first light source 22 and the second light source 24 are arranged.

In the laser device 310, the first laser elements 12 and the second laser elements 14 are irradiated with light from the first light source 22 and the second light source 24 via the optical waveguide, respectively. As illustrated in FIG. 4, in the laser device 310, the first laser element 12 and the second laser element 14 are covered with the third light transmissive member 36. In FIG. 4, the third light transmissive member 36 is divided into a first region covering the upper surfaces of the first laser element 12 and the second laser element 14, and a second region covering the lateral surfaces of the first laser element 12 and the second laser element 14. In one aspect, the first region and the second region of the third light transmissive member 36 may be integrally formed.

FIG. 3B is a schematic top view illustrating a configuration example of a laser device 320. The laser device 320 is configured in the same manner as the laser device 310 except that light emitted from the first laser elements 12 and light emitted from the second laser elements 14 are each emitted in a direction from the first light sources 22 side to the second light sources 24 side. Although light emitted from the first laser elements 12 and light emitted from the second laser elements 14 are emitted in the direction from the first light sources 22 side to the second light sources 24 side in FIG. 3B, light may be emitted in a direction from the second light sources 24 side to the first light sources 22 side.

The laser device may further include: a third laser element that is excited by light emitted from one of the first laser elements and the second laser elements; and a third light source that emits light having a third peak wavelength that allows the photochromic compound included in the third laser element to be changed to a state in which a carrier can be received. The third light source may be disposed in such a manner that the third laser element can be irradiated with light from the third light source, and the third laser element may be disposed in such a manner that the third laser element can be irradiated with light emitted from the first laser element and the second laser element.

When the third laser element excited by emission light of one of the first laser elements and the second laser elements is provided, it is possible to take over first-generation optical information generated by the first laser element and the second laser element to the third laser element as second-generation optical information. When the second-generation optical information is acquired, it is possible to more clearly distinguish the first-generation optical information. In addition, when the number of laser elements and the number of light sources is increased to increase the generation of optical information as in this example, more complicated information can be handled.

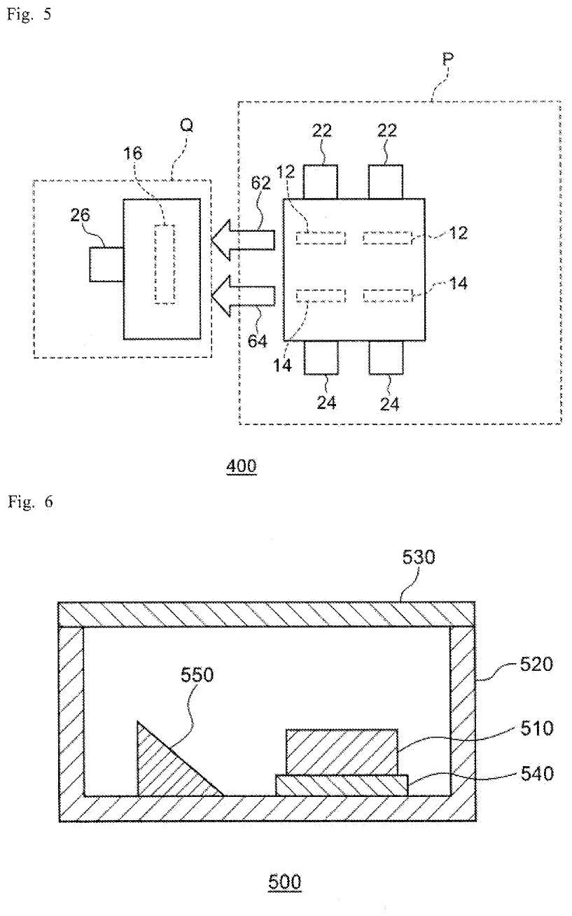

FIG. 5 is a schematic top view illustrating a configuration example of a laser device 400 including a third laser element. The laser device 400 includes first-generation P having a configuration the same as or similar to that of the laser device 310, and second-generation Q including a third laser element 16 and a third light source 26 covered with a light transmissive member. The third laser element is disposed in such a manner to be irradiated with light emitted from the first laser element 12 and the second laser element 14. The third light source 26 is disposed in such a manner that the third laser element 16 can be irradiated with light emitted therefrom. The third laser element 16 is excited by light emitted from one of the first laser elements 12 and the second laser elements 14 to perform laser oscillation. In the third laser element, the photochromic compound included in the third laser element 16 is changed to a state in which a carrier can be received due to light from the third light source 26, and the laser oscillation of the third laser element 16 is stopped. In the laser device 400, the third laser element 16 performs laser oscillation by light emitted from the first laser element 12 or the second laser element 14, and thus states of laser oscillation of the first laser element 12 and the second laser element 14 can be distinguished from each other by the state of laser oscillation of the third laser element 16.

FIG. 6 is a schematic cross-sectional view illustrating a configuration example of a light source device. A light source device 500 includes a base 520, a lid 530, a mirror 550, and a laser device 510. The laser device 510 may be the laser device 100, 200, 210, 310, 320, or 400 described above. The laser device 510 is disposed on the base 520. The laser device 510 may be disposed on the base 520 with a sub-mount 540 interposed therebetween. The mirror 550 may be disposed on the base 520 in such a manner that a reflection surface faces an emission surface of the laser light of the laser device. The base 520 has a recess for accommodating the laser device 510, the sub-mount 540, and the mirror 550. An upper surface of an outer wall forming the recess is joined to the lid 530. The inside of the recess is filled with an inert gas such as nitrogen or argon and is hermetically sealed. In the light source device 500, a laser element of the laser device 510 is protected by a light transmissive member and hermetically sealed by the recess and the lid, whereby the resistance is further improved. Laser light emitted from the laser device 510 is raised by the mirror 550 and extracted from the light source device 500.

### EXAMPLES

The present disclosure will be described in detail below through examples, but the present disclosure is not limited to these examples.

### Reference Example 1

A 100 mg/mL lead (II) acetate aqueous solution was added dropwise on a glass slide and dried at 60° C. for 30 minutes to obtain a lead acetate thin film. The obtained lead acetate thin film was immersed in a 5 mg/mL methylammonium bromide solution containing isopropanol as a solvent for 20 hours under a nitrogen gas atmosphere. In this manner, a gain medium was obtained on the glass slide as a crystal having a perovskite structure and a composition represented by CH₃ NH₃PbBr₃.

PbAc₂(s)+4Br⁻(sol)→PbBr₄²⁻(sol)+2Ac⁻(sol)

PbBr₄²⁻(sol)+CH₃NH₃⁺(sol)

→CH₃NH₃PbBr₃(s)+Br⁻(sol)

Ac⁻ represents an acetate ion. (s) indicates a solid, and (sol) indicates a solution.

### Example 1

A compound having the structure shown below was prepared as a diarylethene derivative. 1.0 ml of isopropanol was added to 10 mg of the diarylethene derivative to prepare a saturated solution containing a precipitate. The supernatant liquid of the saturated solution was added dropwise to the gain medium which was the crystal obtained above, and dried in the air. This caused the diarylethene derivative to be absorbed onto the gain medium to obtain a laser element.

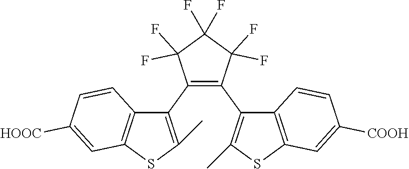 [SMILES: Cc1sc2cc(C(=O)O)ccc2c1C1=C(c2c(C)sc3cc(C(=O)O)ccc23)C(F)(F)C(F)(F)C1(F)F]

### Evaluation Observation of Nonlinear Emission

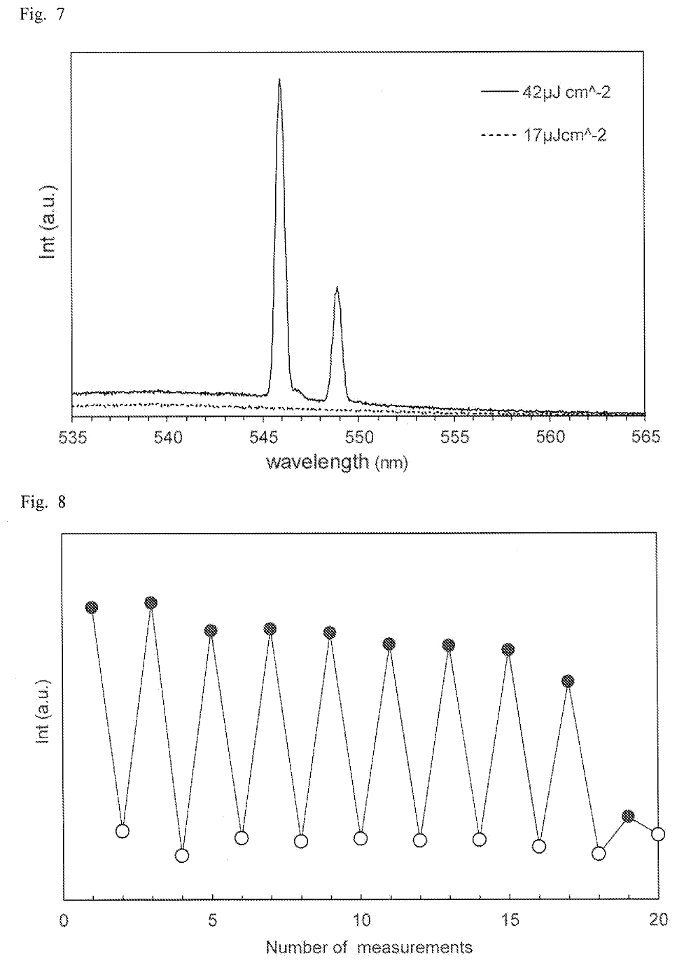

The crystal having a perovskite structure obtained above was used as a sample. Re-amplified femtosecond pulses (Spectra Physics, Solistice, 400 nm, 1 kHz, 100 fs) were guided to a microscope (Olympus, IX-71) and focused on the sample with a 5× objective lens to observe the emission of the laser element. In FIG. 7, a broken line indicates an emission intensity in the case of a pulse energy density of 17 μJcm⁻², and a solid line indicates an emission intensity in a case of a pulse energy density of 42 μJcm⁻².

As shown in FIG. 7, when the excitation light intensity was 17 μJcm⁻², which was an oscillation threshold or less, the maximum emission wavelength was about 540 nm, but when the excitation light intensity was 42 μJcm⁻², which exceeded the oscillation threshold, strong emission was newly observed at around 546 nm and 549 nm. This emission signal suggests nonlinear emission oscillated with the inside of the crystal as a resonator.

### Evaluation Control of Laser Oscillation by Ultraviolet Irradiation

The laser element obtained above was used as a sample. The sample was irradiated with excitation pulse light of 400 nm in the same or similar manner as in the observation of nonlinear emission to adjust the energy density of the excitation pulse light to about the optical oscillation threshold. The sample was irradiated with ultraviolet light in a wavelength range from 300 nm to 400 nm (90 mWcm⁻²; hereinafter, also referred to as UV light) of a xenon lamp for 30 seconds. After the UV light irradiation, the light emission of 548 nm due to optical oscillation is turned off. When the UV light irradiation was stopped and the sample was further irradiated with only the excitation pulse light for 30 seconds, emission due to optical oscillation was again observed. When this procedure was repeated 10 times, optical non-oscillation and oscillation were repeated 8 times. The results are shown in FIG. 8. In FIG. 8, black circles each indicate a state of lasing, and white circles each indicates optical non-lasing. Furthermore, when the laser element was put in a container filled with nitrogen and hermetically sealed and the same procedure was repeated, optical non-lasing and oscillation were similarly repeated about 100 times.

Evaluation Adsorption of Diarylethene Derivative onto Crystal

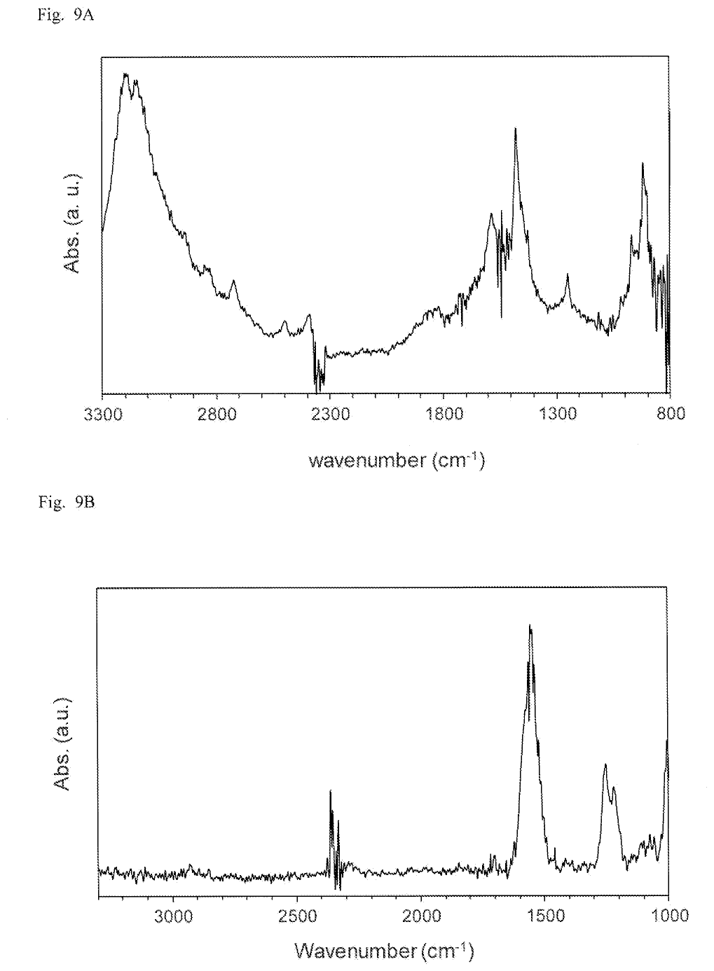

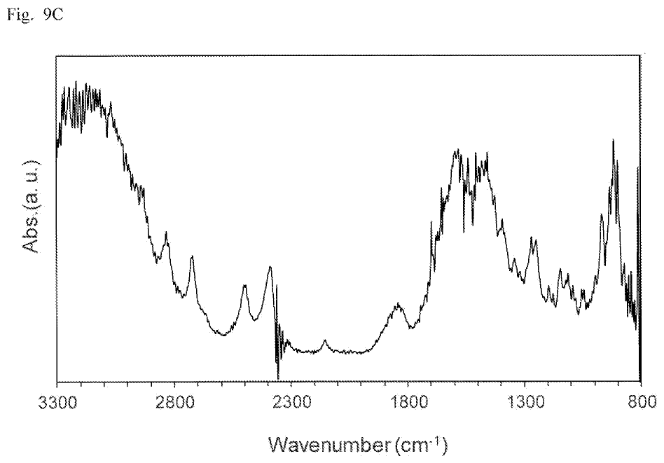

The following experiment was conducted to evaluate whether the diarylethene derivative was adsorbed onto the gain medium. First, CH₃NH₃PbBr₃ serving as the gain medium, and a diarylethene derivative in a ring-opened state were prepared. An infrared absorption spectrum of each of the gain medium and the diarylethene derivative was measured using an IR microscope (available from JASCO Corporation, model number IRT-5200-16). FIG. 9A is an infrared absorption spectrum of CH₃NH₃PbBr₃. FIG. 9B is an infrared absorption spectrum of the diarylethene derivative in a ring-opened state. Subsequently, an infrared absorption spectrum of the laser element of Example 1 was also similarly measured using the IR microscope. FIG. 9C is an infrared absorption spectrum of the laser element of Example 1. In FIG. 9C, the generation of new vibration absorption bands was observed in the vicinity of 1150 cm⁻¹ and 1350 cm⁻¹, as compared to the infrared absorption spectra of FIGS. 9A and 9B. This suggests that some of the functional groups of the diarylethene derivative are bonded to functional groups of the gain medium to cause a shift of a vibration mode. That is, it was presumed that the diarylethene derivative was adsorbed onto the gain medium.

It is to be understood that although the present invention has been described with regard to preferred embodiments thereof, various other embodiments and variants may occur to those skilled in the art, which are within the scope and spirit of the invention, and such other embodiments and variants are intended to be covered by the following claims.

Although the present disclosure has been described with reference to several exemplary embodiments, it is to be understood that the words that have been used are words of description and illustration, rather than words of limitation. Changes may be made within the purview of the appended claims, as presently stated and as amended, without departing from the scope and spirit of the disclosure in its aspects. Although the disclosure has been described with reference to particular examples, means, and embodiments, the disclosure may be not intended to be limited to the particulars disclosed; rather the disclosure extends to all functionally equivalent structures, methods, and uses such as are within the scope of the appended claims.

One or more examples or embodiments of the disclosure may be referred to herein, individually and/or collectively, by the term “disclosure” merely for convenience and without intending to voluntarily limit the scope of this application to any particular disclosure or inventive concept. Moreover, although specific examples and embodiments have been illustrated and described herein, it should be appreciated that any subsequent arrangement designed to achieve the same or similar purpose may be substituted for the specific examples or embodiments shown. This disclosure may be intended to cover any and all subsequent adaptations or variations of various examples and embodiments. Combinations of the above examples and embodiments, and other examples and embodiments not specifically described herein, will be apparent to those of skill in the art upon reviewing the description.

In addition, in the foregoing Detailed Description, various features may be grouped together or described in a single embodiment for the purpose of streamlining the disclosure. This disclosure may be not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter shall be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure may be determined by the broadest permissible interpretation of the following claims and their equivalents, and shall not be restricted or limited by the foregoing detailed description.

All publications, patent applications, and technical standards mentioned in this specification are herein incorporated by reference to the same extent as if each individual publication, patent application, or technical standard was specifically and individually indicated to be incorporated by reference.

What is claimed is:

1. A laser element comprising:
a gain medium; and
a photochromic compound that receives a carrier from the gain medium, wherein,
the gain medium comprises a first ion, a second ion, and an anion or a ligand in a composition of the gain medium,
the first ion includes at least one selected from the group consisting of an alkali metal ion, an ammonium ion, a formamidinium ion, a guanidium ion, an imidazolium ion, a pyridinium ion, a pyrrolidinium ion, and a protonated thiourea ion,
the second ion includes at least one selected from the group consisting of lead, germanium, tin, antimony, and bismuth, and
the anion or the ligand including at least one selected from the group consisting of a chloride ion, a bromide ion, an iodide ion, a cyanide ion, a thiocyanate, an isothiocyanate, and a sulfide.

2. The laser element according to claim 1, wherein the gain medium includes a crystal having a perovskite structure.

3. The laser element according to claim 1, wherein the gain medium comprises a composition represented by the following Formula (1):
[M¹_{w}A¹_{(1-w)}]ₓM²_{y}X_{z} (1),
where in Formula (1),
M¹ represents a first ion including at least one selected from the group consisting of Cs, Rb, K, Na, and Li,
A¹ represents a non-metal cation including at least one selected from the group consisting of an ammonium ion, a formamidinium ion, a guanidium ion, an imidazolium ion, a pyridinium ion, a pyrrolidinium ion, and a protonated thiourea ion,
M² represents a second ion including at least one selected from the group consisting of Ge, Sn, Pb, Sb, and Bi,
X represents an anion or a ligand including at least one selected from the group consisting of a chloride ion, a bromide ion, an iodide ion, a cyanide ion, a thiocyanate, an isothiocyanate, and a sulfide,
x is a number in a range from 1 to 4, y is a number in a range from 1 to 2, z is a number in a range from 3 to 9, and w is a number in a range from 0 to 1, and
In a case in which both M¹ and A¹ are included in Formula (1), both M¹ and A¹ represent an atomic group constituting a perovskite structure.

4. The laser element according to claim 1, wherein the photochromic compound is a P-type photochromic compound.

5. The laser element according to claim 1, wherein the photochromic compound includes a diarylethene derivative.

6. The laser element according to claim 1, wherein the photochromic compound is adsorbed onto the gain medium.

7. The laser element according to claim 1, wherein the gain medium has a total of a longitudinal length, a lateral length, and a height in a range from 500 nm to 50 μm.

8. The laser element according to claim 1, wherein an absorption spectrum of the gain medium has a wavelength that allows the photochromic compound to be changed to a state in which a carrier is receivable in at least a part of a wavelength range in which a transmitted light intensity is 50% or more of a maximum value of the transmitted light intensity.

9. The laser element according to claim 1, further comprising:
a container accommodating the gain medium and the photochromic compound, wherein
an inside of the container is filled with an inert gas.

10. A laser device comprising:
the laser element according to claim 1;
a first light source configured to emit light having a first peak wavelength; and
a second light source configured to emit light having a second peak wavelength, wherein
the first peak wavelength allows the photochromic compound to be changed to a state in which reception of a carrier is suppressed,
the second peak wavelength allows the photochromic compound to be changed to a state in which a carrier is receivable, and
at least one of the first peak wavelength or the second peak wavelength allows the gain medium to be excitable.

11. The laser device according to claim 10, further comprising
a first light transmissive member and a second light transmissive member, wherein,
the laser element is located between the first light transmissive member and the second light transmissive member.

12. The laser device according to claim 11, wherein,
the laser element comprises a first laser element and a second laser element, and
in a cross section including the first light transmissive member, the second light transmissive member, the first laser element, and the second laser element,
the first laser element and the second laser element are surrounded by the first light transmissive member and the second light transmissive member, respectively, and
at least one of the first light transmissive member and the second light transmissive member is disposed between the first laser element and the second laser element.

13. The laser device according to claim 10, further comprising:
a light transmissive member; and
an optical waveguide optically coupled to each of the first light source and the second light source, wherein,
the laser element and the light transmissive member are located on the optical waveguide, and
the laser element is located between the optical waveguide and the light transmissive member.
